(19) United States
(12) Patent Application Publication
(10) Pub. No.: US 2025/0276477 A1
(43) Pub. Date: Sep. 4, 2025

(54) HOT RUNNER CONTROL DEVICE AND METHOD OF OPERATING A HOT RUNNER CONTROL DEVICE

(71) Applicant: Gammaflux Controls, Inc., Bristol, CT (US)

(72) Inventor: Julien Caestecker, Concord, NC (US)

(21) Appl. No.: 18/592,930

(22) Filed: Mar. 1, 2024

(51) Int. Cl. B29C 45/27

(52) U.S. Cl. CPC B29C 45/2738; B29C 2045/275; B29C 2045/2751; B29C 2945/76946

(57) ABSTRACT

The present disclosure relates to a hot runner control device for a hot runner assembly and a method of operating a hot runner controller, which comprises a signature element, the hot runner control device comprises a processor configured to receive a signature from the signature element, the signature being characteristic for the signature element of the hot runner assembly, the processor is further configured to access a database comprising at least one reference signature being characteristic for at least one of the signature elements, and the processor is further configured to identify the signature element of the hot runner assembly, by comparing the received signature with the at least one reference signature.

### FIELD OF THE DISCLOSURE

The present disclosure relates to a hot runner control device and to a method of operating a hot runner control device. The present disclosure relates in particular to a hot runner control device for a hot runner assembly installed in an injection molding device and to a method for operating such a hot runner control device.

### BACKGROUND OF THE DISCLOSURE

In the field of injection molding of plastic materials using injection molding devices, hot runner control devices are typically configured to control at least one hot runner assembly of the respective injection molding device. The hot runner control device may be a stand alone device connected to the hot runner assembly of the injection molding device or may be integrated in the injection molding device. The hot runner is typically an assembly of heated components used for distributing melded plastic material to be injected into the cavities of an injection mold in the injection molding device.

The hot runner control device is in particular configured to control the temperature of the hot runner assembly during its operation for an optimized operation of the entire injection molding device. The hot runner control device is usually further configured to receive measured signals from the hot runner assembly in particular for controlling it.

Conventional hot runner control devices are configured to control a plurality of different hot runner assembly types and sometimes they are in principle even capable to control hot runner assemblies from different manufacturers of hot runner assemblies. The plurality of different hot runner assemblies are for example used to produce different parts in one or a plurality of injection molding devices. Each of the different hot runner assemblies requires different parameters, e.g. startup parameters, power parameters, etc., for an optimized operation.

Conventionally, the hot runner control device is manually adjusted for each connected hot runner assembly. This means that an experienced user of the hot runner control device is required to set the control parameters for the connected hot runner assembly for an optimized operation of the hot runner assembly and the entire injection-molding device.

Further, it is currently not technically possible to limit the operational range or the functionalities of the hot runner control device in dependence of the connected hot runner assembly. For the hot runner control device and the hot runner assembly to operate efficiently they need to be well calibrated with respect to each other, therefore both are normally sold as a bundle. However, if a user uses the hot runner control device for controlling a different hot runner assembly it is currently not possible to detect this or to limit the operational range or the functionalities. Currently it is almost impossible to detect if the hot runner control device and/or the hot runner assembly are being misused in particular by setting wrong control parameters, which could harm in particular the hot runner assembly and the entire injection molding device.

### SUMMARY OF THE DISCLOSURE

Conventional hot runner control devices have several disadvantages as described above. It is therefore an object of the present disclosure to address at least some of the disadvantages of the known state of the art.

A first aspect of the present disclosure is directed to a hot runner control device for a hot runner assembly comprising a signature element installed in an injection molding device. The hot runner control device further comprises a processor, which is in particular configured to receive a signature from the signature element. The signature is characteristic for the signature element of the hot runner assembly. In other words, the signature is capable of characterizing the signature element of the hot runner assembly, e.g. from a plurality of potential signature elements. The processor is further preferably configured to access a database comprising at least one reference signature being characteristic for at least one of the signature elements. The database is e.g. located in the hot runner control device, in particular in a readable memory, which is preferably encrypted. In a variation, the database is arranged outside of the hot runner control device, e.g. on a remote server, in particular a cloud server. In this case, the processor is configured to access the respective database, via a communication link, e.g. a wired or wireless communication. Locating the database outside and/or encrypting the database provides a fraud protection advantage. In addition, the database, arranged inside or outside, may offer the possibility to be updated, e.g. by loading a new reference signature of a newly developed and released hot runner assembly in the database. Further, the already stored reference signatures may be updated.

The processor of the hot runner control device may be further configured to identify the signature element of the hot runner assembly, by comparing the received signature with the at least one reference signature. The identification of the signature element of the hot runner assembly is possible by comparing the received signature with the one or the plurality of stored reference signatures. When the received signature matches with the at least one reference signature, the respective signature element is identified. In case the received signature element does not match with any one of the reference signatures, the respective signature element sending the reference signature may be identified in that it is not one of the expected signature elements. In other words, a mismatch is identified.

In a variation, receiving a signature may also comprise that no signature is received, in particular after the hot runner control device requests to receive a signature from the signature element. In particular a signature element from manufactured by a third party may not be capable of sending any respective signature. Receiving no signature may therefore be regarded as receiving an unidentifiably signature.

The signature is e.g. a signal or a code, which is processable by the processor of the hot runner control device and which is characteristic for the signature element. The processor of the hot runner control device may request to send the signature, the signature element may send the signature automatically, or the signature is transmitted to the processor of the hot runner control device in that the hot runner control device receives a measurement signal from the signature element. The hot runner control device may trigger to measure the signature element. Other options of receiving the signature are also conceivable. The hot runner control device is e.g. electrically via a wireless or via a wired connection connected to the hot runner assembly, for transferring control parameters from the hot runner control device and for receiving signal measurements and of course for receiving the signature.

In an advantageous variation, the signature may comprises an identifier, a data point, a measured signal, a measured signal curve and/or a data series from the signature element, and wherein the reference signature comprises the corresponding reference identifier, reference data point, reference signal, reference signal curve, reference data curve, or reference data series. The identifier is a data package e.g. encrypted, which is characteristic for the signature element. The data point is e.g. signature element type information. The measured signal, is e.g. a signal point characteristic for a measurable parameter of the signature element, for example a measured temperature or a measured electrical resistance at a specific point in time. The measured signal curve is a signal curve characteristic for a parameter curve of the signature element, for example a measured temperature curve from a first point in time to a second point in time. The data series comprises a plurality of data points forming in combination the data series. The data points are for example collected by the signature element during its operation and send to the hot runner control device when required. Other signatures or a combination of the aforementioned are of course also conceivable.

In order to advantageously identify not only the signature element, but also the hot runner assembly, the processor of the hot runner control device is configured to identify the hot runner assembly based on the identified signature element. The signature element forms part of the hot runner assembly. The signature element may be different for each type of hot runner assembly, which makes it advantageously possible to identify the hot runner assembly. In case the signature element is used for a plurality of different hot runner assembly types it is still possible to identify the group of hot runner assembly types, which use the respective signature element. In a further variation, the processor may receive a plurality of signatures from a plurality of signature elements of the hot runner assembly, e.g. from two parts. In this case, it would be even more advantageously possible to identify the installed hot runner assembly by using the plurality of identified signature elements.

In an advantageous variation is the processor configured to identify the signature element type and/or the hot runner assembly type by comparing the received at least one signature, which is characteristic for the respective signature element type and/or which is characteristic for the respective hot runner assembly type, with the at least one reference signature, which is characteristic for the signature element type and/or the hot runner assembly type. It is therefore possible to identify the installed signature element type or the installed hot runner assembly type.

In an additional advantageous variation is the processor further configured to identify the individual signature element and/or the individual hot runner assembly by comparing the received signature, which is characteristic for the respective individual signature element and/or which is characteristic for the respective individual hot runner assembly with the at least one reference signature which is characteristic for the individual signature element and/or the individual hot runner assembly. In this variation, the signature may be or comprise a unique identifier, which uniquely identifies the signature element or the hot runner assembly, like a vehicle identification number an individual token. Is therefore possible to control and track the individual signature element and/or the individual hot runner assembly throughout their entire lifetime. This has the advantage that the hot runner assembly can be traced and monitored by the original equipment manufacturer throughout its entire lifetime even if a first buyer sells the hot runner assembly to a third party.

An advantageous simple and reliable identification of the signature element is possible when the signature element is a heater element of the hot runner assembly and the received signature is characteristic for the heater element of the hot runner assembly. The heater element is the part or the plurality of parts of the hot runner assembly, which are configured to heat at least a portion or the entire hot runner assembly. The heater element may be e.g. configured to heat nozzles of the hot runner assembly. The hot runner assembly may comprise one or a plurality of heater elements. One of the heater elements may be the respective signature element. In another variation, a plurality of the heater elements are the signature element or the signature elements all sending the respective signature to the hot runner control device. The heater element is preferably an electrical heater element, which heats the hot runner assembly by resistance heating. This is controlled by the hot runner control device, e.g. in that the hot runner control device controls directly or indirectly the electrical current flowing through the heater element. The hot runner control device is therefore preferably electrically connected to the heater element.

In an advantageous variation is when the received signature comprises the measured signal or the measured signal curve measured at the signature element, in particular at the heater element, which characterizes the signature element. The signature is according to this variation measured e.g. by a sensor arranged on or within the hot runner assembly. The measurement is than transmitted from the hot runner assembly and received by the processor of the hot runner control device. The hot runner control device may be directly connected to the sensor. In another variation, the hot runner control device may measure the signature by itself. Measurements as signature are advantageously reliable, in particular because they are harder to counterfeit.

In a further variation, the measured signal or measured signal curve is characteristic for a measurable parameter of the signature element, in particular an electrical resistance of the signature element and/or a temperature measured at or in the signature element or the hot runner assembly. The measureable parameter of the signature element may be any parameter, which can characterize the signature element. As mentioned, the electrical resistance or the temperature might be such a parameter. A combination of parameters may also be conveivable, e.g. the electrical resistance over electrical current, over time, the electrical current over temperature, over time or vice versa. Other parameters, like magnetic parameters are also conceivable. For example, each signature element, in particular each heater element, has a characterizing individual electrical resistance, when electrical current is guided through the signature element. This individual electrical resistance may be measured, e.g. over time, in particular by a respective sensor and transmitted to and received by the processor of the hot runner control device for identification of the respective signature element. The same is applicable with a temperature, e.g. after a predetermined amount of electrical current is applied on the heater element.

In a further variation, the signature element as measured signal or measured signal curve may be dependent on another parameter like time or temperature. For example, the measured temperature at the signature element is applied over time (during its operation) or over energy provided to the signature element. Further, the measured electrical resistance is applied over time or over temperature or over energy provided to the signature element. In this variation, it is possible to measure a characteristic curve or head curve, which is used as the signature. Such characteristic curves are advantageously as signature because they are highly individual for different signature elements and/or hot runner assemblies etc.

In a further advantageous variation is the processor of the hot runner control device configured to control the hot runner assembly, in particular by setting control parameters in the hot runner control device, in dependence of the identified signature element, for operating the hot runner assembly by the hot runner control device. Each hot runner assembly type needs specific control parameters for an optimized operation. By automatically identifying the installed signature element and the hot runner assembly, it is possible to automatically set the respective control parameters for the desired advantageous operation of the identified hot runner assembly. The respective control parameters are accessible, e.g. stored in a respective data base, for the processor of the hot runner control device and loaded in dependence of the identified signature element or identified hot runner assembly. Setting the control parameters manually is omitted.

An advantageous startup process of the hot runner assembly and/or of the entire injection molding device is realizable when controlling the hot runner assembly comprises to set start-up process parameters in dependence of the identified signature element for controlling a startup process of the hot runner assembly. The startup process of a hot runner assembly and/or of the injection molding device is crucial for the quality of the resulting molded parts. The startup process is conventionally an iteration of try and error over a long timespan for configuring the control parameters of the hot runner assembly and the entire injection molding device for an optimized operation of the system. Switching the hot runner assembly would require a new startup process. According to this variation it is possible to load and set, by the processor of the hot runner control device, from the beginning the right startup parameters for an advantageous startup operation and normal operation of the hot runner assembly.

In a further advantageous variation, the processor of the hot runner control device is further configured to limit the available functionalities and/or to limit the operational range of functionalities in case the received signature does not match to at least one reference signature when compared to the reference signature. In this case a mismatch situation is detected. This may happen if the hot runner assembly used in the injection molding device originates from a third party manufacturer or the hot runner assembly is to old for being referenced. In this case, the hot runner control device, in particular its processor, is configured to restrict or limit the normal available functions for the third party hot runner assembly and/or to limit the operational range of the functions for the third party hot runner assembly. Restricting may comprise that specific functions, like a boost heating function, may be enabled. Limiting the operational range may comprise for example, that the maximum power for heating is limited by e.g. 25% or more.

It is of course also conceivable that the respective hot runner control device inhibits all functionalities in case of identifying a mismatch, such that operating the third party hot runner assembly is inhibited entirely by the hot runner control device. In this case, the hot runner control device is operatable only with respective hot runner assemblies, which are identified using the received signature. Third party products are not compatible with the hot runner control device.

According to a further advantageous variation, in case the received signature does not match to at least one reference signature the processor of the hot runner control device is further configured to store in a readable memory of the hot runner control device a mismatch information, which determines that the received signature could not be identified and/or transmit mismatch information to a server device located outside of the hot runner control device, in particular a cloud server, which is not located at the installation site of the injection molding device. The information that it has been tried to use the hot runner control device for operating an unidentifiable hot runner assembly, e.g. from a different OEM, is stored in the readable memory, preferably encrypted, or is transmitted, by the processor, via a communication interface, e.g. via a mobile communication network and/or the internet, to a server device, which is preferably controlled by the manufacturer of the hot runner control device. This enables the manufacturer to remotely monitor and control the usage of its hot runner control devices and/or its hot runner assemblies. Operators of the hot runner control device, which only use the hot runner control device with respective identifiable hot runner assemblies may be rewarded and other user, which misuse the hot runner control devices or the hot runner assemblies may be punished, e.g. automatically. A mismatch may also be detected if no signature is received by the processor of the hot runner control device, in particular after requesting the transmittal of the signature.

In a further variation, the processor of the hot runner control device being further configured to determine at least one wear parameter of the hot runner assembly, by using the received signature, in particular by determining and using variations in the received signature over time. The hot runner control device may be configured to constantly receive the signature during operation of the injection molding device. In this variation, the signature may further be used to determine the wear over time of the signature element and/or of the entire hot runner assembly. The signature is in this variation preferably a measured signal or a measured signal curve from the signature element. Further, the signature may comprise cycle times or another parameter, which may be used to identify the wear parameter of the signature element. Receiving the signature constantly means e.g. that the signature is received at predetermined time intervals or predetermined points in time or permanently.

Further, the processor of the hot runner control device may be configured to receive constantly from the plurality of signature elements, e.g. from the plurality of the heater elements the signature, which enables the processor to identify for each signature element the respective wear parameter, by using the plurality of received signature elements. For example, the measured electrical resistance or the measured temperature as the received signature may change over time, which is indicative for a respective wear of the respective signature elements.

In an advantageous further variation, the processor of the hot runner control device is further configured to determine maintenance recommendations and in particular to display the determined maintenance recommendations to a user of the hot runner control device, in case the determined at least one wear parameter of the hut runner assembly fulfills a predefined threshold, indicating maintenance requirement of the hot runner assembly. The signature element may be advantageously be used for determining the maintenance recommendations, which than may be displayed or presented to the user, further such maintenance information may also be stored in the memory or may be transmitted to the (cloud) server via the communication interface.

In a further variation, the processor of the hot runner control device is further configured to control the hot runner assembly in dependence of the determined wear parameter. The wear of the signature element or of the hot runner assembly may limit its maximum capabilities. This is according to this variation taken into account in that the determined wear parameter influences controlling of the hot runner assembly, e.g. in that the operational range of certain functionalities is limited or in that certain functionalities are switched off after a specific threshold is fulfilled.

According to a further aspect of the present disclosure, a method of operating a hot runner control device for a hot runner assembly is disclosed. The hot runner assembly comprises a signature element installed in an injection molding device, the method comprising the step of receiving, from the signature element a signature, which is characteristic for the signature element of the hot runner assembly. The method further comprises the step of accessing, a database comprising at least one reference signature being characteristic for at least one signature element. The method further comprises the step of identifying the signature element of the hot runner assembly, by comparing the received signature with the at least one reference signature. All of the mentioned variations and embodiments and the respective advantages and technical effects with respect to the hot runner control device as disclosed above and hereinafter are applicable and thereby herewith disclosed mutatis mutandis with respect to the method of operating the hot runner control device.

It is to be understood that both the foregoing general description and the following detailed description present variations, and are intended to provide an overview or framework for understanding the nature and character of the disclosure. The accompanying drawings are included to provide a further understanding, and are incorporated into and constitute a part of this specification. The drawings illustrate various variations, and together with the description serve to explain the principles and operation of the concepts disclosed.

### BRIEF DESCRIPTION OF THE DRAWINGS

The herein described disclosure will be more fully understood from the detailed description given herein below and the accompanying drawings, which should not be considered limiting to the disclosure described in the appended claims. The drawings are showing:

FIG. 1 a perspective schematic view of a hot runner control device and a hot runner of an injection molding device;

FIG. 2 a schematic view of a plurality of received signatures and a plurality of reference signatures stored in a database;

FIG. 3 a schematic diagram representing a measured signature according to an exemplary variation from the signature element;

FIG. 4 a first schematic flow chart illustrating a plurality of steps, which are performable by a processor of the hot runner control device, according to a first variation;

FIG. 5 a second schematic flow chart illustrating a plurality of steps, which are performable by the processor of the hot runner control device, according to a second variation;

FIG. 6 a third schematic flow chart illustrating one step, which is performable by the processor of the hot runner control device, according to a third variation;

FIG. 7 a fourth schematic flow chart illustrating steps, which are performable by the processor of the hot runner control device, according to a fourth variation;

FIG. 8 a fifth schematic flow chart illustrating steps, which are performable by the processor of the hot runner control device, according to a fifth variation;

FIG. 9 a sixth schematic flow chart illustrating steps, which are performable by the processor of the hot runner control device, according to a fifth variation;

FIG. 10 a seventh schematic flow chart illustrating steps, which are performable by the processor of the hot runner control device, according to a seventh variation.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

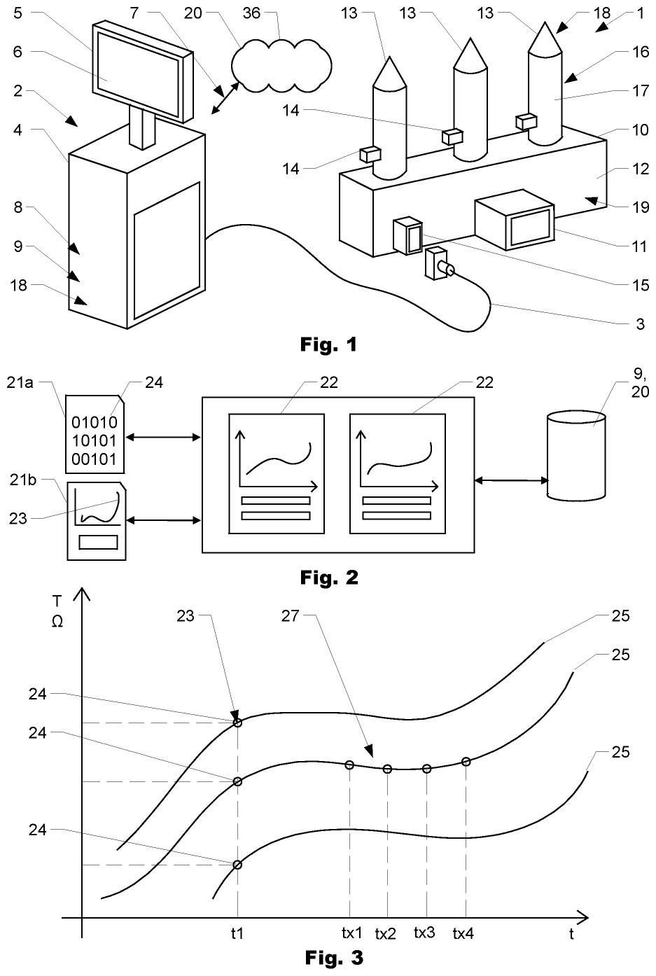

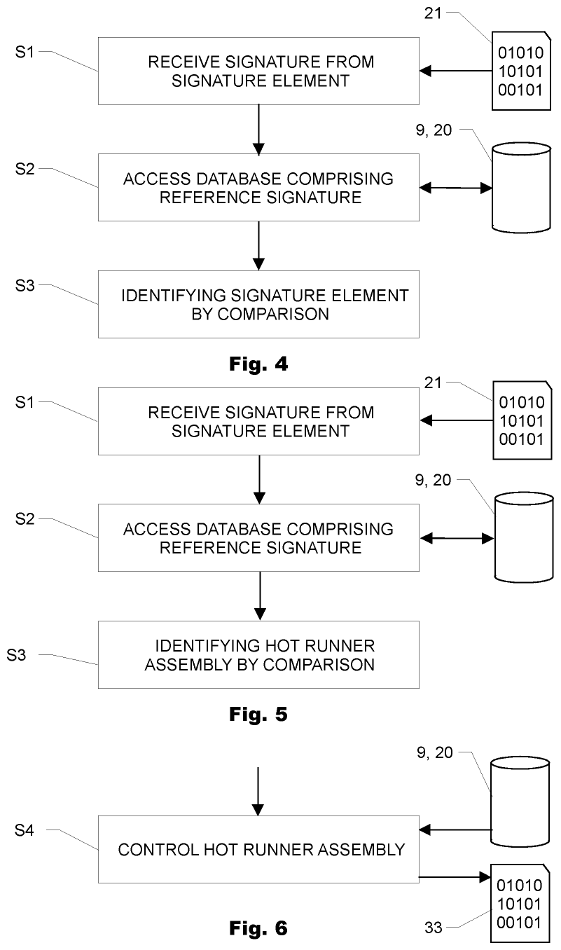

FIG. 1 shows a perspective schematic view of a hot runner control device 2 and a hot runner assembly 10 of an injection molding device 1. FIG. 2 shows a schematic view of a plurality of signatures 21 and reference signatures 22 stored in a database 9, 20. FIG. 3 shows a schematic diagram representing a measured signature 24, 25 according to an exemplary variation received from the signature element 16. FIGS. 4 to 10 show schematic flow charts illustrating at least one step, which is performable by a processor 8 of the hot runner control device 2. The processor 8 may be a single processor configured to perform all functionalities, or a plurality of processors 8, which are configured for a plurality of functionalities. The processor 8, may be a computer, an application-specific integrated circuit, ASIC, an electronic circuit or any other device, having the required capabilities.

FIG. 1 shows a perspective schematic view of a hot runner control device 2 and a perspective schematic view of a hot runner assembly 10. The hot runner control device 2 and the hot runner assembly 10 may form part of an injection molding device 1. The hot runner control device 2 is according to this variation a stand alone device, which is connected via a wired connection 3 to the hot runner assembly 10. The hot runner control device 2 may comprise a processor 8, a housing 4, a user interface 6, e.g. a touch sensitive display 5. The processor 8 is configured to control the hot runner control device 2 and the hot runner assembly 10, in particular by processing data input, user input, signal input to control instructions for controlling of the hot runner assembly 10. The hot runner control device 2 may further comprise a readable memory or database 9, which is configured to store data and to provide the stored data to the processor 8 if requested. The hot runner control device 2 may further comprise a communication interface 7 configured for a wired or wireless communication with other devices, like smartphones, servers devices 36 etc. The wired connection 3 to the hot runner assembly 10 is e.g. configured to transmit control parameters 33 to the hot runner assembly 10, to transmit data or signals from the hot runner assembly 10 to the hot runner control device 2 and/or to transmit electrical current for operating the hot runner assembly 10.

The hot runner assembly 10 as shown in FIG. 1 comprises a mold inlet 11, a mold manifold 12, three nozzles 13, sensors 14 arranged at the nozzles 13 and heater element 17. The heater element 17 is according to this variation a signature element 16, which is configured to characterize the hot runner assembly 10. Each nozzle 13 may comprise a respective heater element 17, arranged preferably around a mold channel for heating the respective mold during operation of the hot runner assembly 10. The hot runner assembly 10 is configured during its operation to guide the mold or melt from the mold inlet 11 via the mold manifold 12 to the nozzles 13 such that the nozzles 13 can fill the respective cavity of the injection molding device 1 for forming the respective parts. The mold manifold 12 and or the nozzles 13 may comprise heater elements 17, in particular electrical resistance heater elements, which are configured to heat the respective parts such that the mold or melt has the required temperature while passing through the hot runner assembly 10 and while being injected into the cavity. The sensors 14 are for example temperature sensors or electrical resistance sensors and are configured to provide sensor signals via the connection 3 to the hot runner control device 2. The hot runner assembly 10 further comprises a control interface 15, which is configured to be connected to a plug of the connection line 3. The control interface 15 provides an electrical connection to the hot runner control device 2 such that e.g. data from the hot runner assembly 10 is transferable to the hot runner control device 2 and such that e.g. control parameters 33 are transferable from the hot runner control device 2 to the hot runner assembly 10. In a further variation, the control interface 15 may be configured to receive the electrical current for heating of the respective parts of the hot runner assembly 10. The control interface 15 may comprise respective plug capabilities. A wireless communication between the hot runner control device 2 and the hot runner assembly 10 may also be conceivable in an alternative variation.

FIG. 2 shows a plurality of received signatures 21 and a plurality of reference signatures 22 stored in a database 18. The signatures 21 are depicted on the left of FIG. 2. A first signature 21a is shown, which comprises an identifier 26, comprising e.g. a key, which characterizes the respective signature element type 18, the respective hot runner assembly type 19 or the individual signature element 16 or the individual hot runner assembly 10. A second signature 21b is additionally shown, which comprises a measured signal curve 25, which characterizes the respective signature element 16 etc. . . . The signatures 21 are configured to characterize the signature element 16 of the hot runner assembly 10 and are analyzed by the hot runner control device 2 respectively for identifying the installed signature element 16 and/or the installed hot runner assembly 10. FIG. 2 shows in the middle section schematically a plurality, in particular two, reference signatures 22, which are e.g. stored in a database 9, 20. The database 9 is for example arranged directly in the hot runner control device 2 or is a remotely accessible database 20. In the latter case, the database 20 may be a cloud server, which is accessible by the hot runner control device 2. Other variations are also conceivable. FIG. 2 shows that the reference signatures 22 differ from one another and are thereby characteristic for different signature elements 16 or signature element types 18.

FIG. 3 shows a schematic diagram representing a signature 21 from the signature element 16, which is characteristic for the signature element 16 installed in the hot runner assembly 10. The signature 21 as shown in FIG. 3 comprises a plurality of measures signal curves 25, which are for example measured by the three sensor 14 of the three nozzles 13 as shown in FIG. 1. Each measured signal curve 25 is according to this variation representative for the signature 21 of each nozzle 13, in particular of the heater element 17 of each nozzle 13. Having a plurality of measured signal curves 25 as signature 21 increases the accuracy of identification. The measured signal curve 25 as shown in FIG. 3 are e.g. a temperature measurement T or an electronic resistance measurement Q over time t. Other measurable parameters of the signature element 16 of the respective hot runner assembly 10 are of course also conceivable.

FIG. 3 further shows that one or a plurality of measured signal 24, e.g. at a predefined point in time t1 could also be used as signature 21. Further, a single data point 23, could also be used as respective signature 21 according to a further variation. In yet another variation, a data series 27 e.g. captured at different points in time tx1-4 could also be used as respective signature 21. The signature 21 may be anything, which is capable of characterizing at least the signature element 16, the signature element type 18, the hot runner assembly 10 and/or the hot runner assembly type 19. The reference signature 22 corresponds to the respective type of received signature 21 e.g. a reference data point 28, a reference signal 29, a reference signal curve 30, a reference identifier 31, a reference data series 32. For example, in case the received signature 21 is a measured signal curve 25, the respective at least one reference signature 22 also needs to be a reference signal curve 30 or an equivalent, such that the received signature 21 can be compared with the reference signature 22. In case the received signature 21 comprises the identifier 26, e.g. an encrypted key, the reference signature 22 may be a corresponding reference identifier 31 in particular a corresponding key or may be verification equivalent, which is configured to compare and identify the received encrypted key. In this case, matching means that the received identifier 26 is successfully associated with the respective signature element 16, the respective signature element type 18, the respective hot runner assembly 10 and/or the respective hot runner assembly type 19.

FIG. 4 shows a first schematic flow chart illustrating a sequence of steps for identifying the signature element 16 of a hot runner assembly 10, in particular performed by the processor 8 of the hot runner control device 2.

In step S1, the processor 8 receives the signature 21 from the signature element 16. The signature 21 is for example automatically received after startup of the hot runner control device 2, is received by a request from the hot runner control device 2, is received in that the hot runner control device 2 conducts a measurement, is received constantly or at predetermined time intervals, is received triggered by the user. The target is, that the hot runner control device 2 is enabled to assess and process the signature 21 from the at least one signature element 16 of the hot runner assembly 10. Receiving the signature 21 further includes that the processor 8 of the hot runner control device 2 accesses the hot runner assembly 10 for assessing and processing of its signature 21. The signature 21 may be any signal, information or data package, which is configured to characterize the signature element 16, the signature element type 18, the hot runner assembly 10 and/or the hot runner assembly type 19, as described previously more detailed, in particular with respect to FIG. 3.

In step S2, the processor 8 accesses a database 9, 20, which comprises at least one reference signature 22, which is characteristic for at least one of the signature elements 4. The database 9, 20 is e.g. a database 9 located in the hot runner control device 2 or a remote database 20 located at a server device 36. The database 9, may be implemented in the processor 8. In other words, the database 9, 20 provides an access possibility for the processor 8 to use the reference signatures 22 of the different signature elements 16. The reference signatures 22 are e.g. measured signal curves 25, which have been recorded e.g. by the manufactures of the different signature elements 16 and which are stored in the respective database 9, 20. The reference signature 22 is therefore uniquely characteristic for the signature element 16, the signature element type 18, the hot runner assembly 10 comprising the signature element 16 and/or the hot runner assembly type 19. In other words, the at least one reference signature 22 is configured to identify all or a portion of the signature elements 16 etc. as desired.

In step S3, the processor 8 identifies the signature element 16 of the hot runner assembly 10, in particular by comparing the received signature 21 with the at least one reference signature 22. Identifying may mean that the received signature 21 is associated to one of the references signatures 22 with a high enough correlation e.g. a 80% match or higher. This may be in particular the case if the signature is a measured signal 24 or a measured signal curve 25. In case the signature 21 is an identifier 26, the match may reach 100% correlation. Important is, that the received signature 21 and the reference signature 22 are both used to identify the signature element 16 of the hot runner assembly 10 from which the signature 21 is received. Other variations of comparing the signature 21 and the reference signature 22 are also conceivable.

FIG. 5 shows a second schematic flow chart illustrating a sequence of steps for identifying the hot runner assembly 10 comprising the signature element 16, in particular performed by the processor 8 of the hot runner control device 2.

The steps S1 and S2 of FIG. 4 correspond to the steps S1 and S2 as described with respect to FIG. 3.

In step S3, the processor 8 identifies the hot runner assembly 10 of the injection molding device 1, in particular by comparing the received signature 21 or the plurality of received signatures 21 with the respective stored at least one reference signature 22. Each hot runner assembly 10 or each hot runner assembly type 19 may be equipped with one or a plurality of signature elements 16, which enable to identify the individual hot runner assembly 10 or the hot runner assembly type 19. It is therefore not only possible to identify the signature element 16, e.g. the heater element 17 of the hot runner assembly 10, but the individual hot runner assembly 10 and/or the hot runner assembly type 19.

FIG. 6 shows a third schematic flow chart illustrating an additional step, in particular performed by the processor 8 of the hot runner control device 2.

In step S4, the processor of the hot runner control device 2 controls the hot runner assembly 10, at least the signature element 16 e.g. the at least one heater element 17, in dependence of the identified signature element 16, in dependence of the identified signature element type 18, in dependence of the identified individual hot runner assembly 10 and/or in dependence of the identified hot runner assembly type 19. Controlling may include that the processor 8 loads specific control data from a database 9, 20 and/or sends specific control parameters 33, determined in particular by using the loaded control data from the database 9, 20, to the hot runner assembly 10. In other words, controlling S4 of the hot runner assembly 10 comprises that the operation of the hot runner assembly 10 is controlled in dependence of the identified signature element 16 etc.

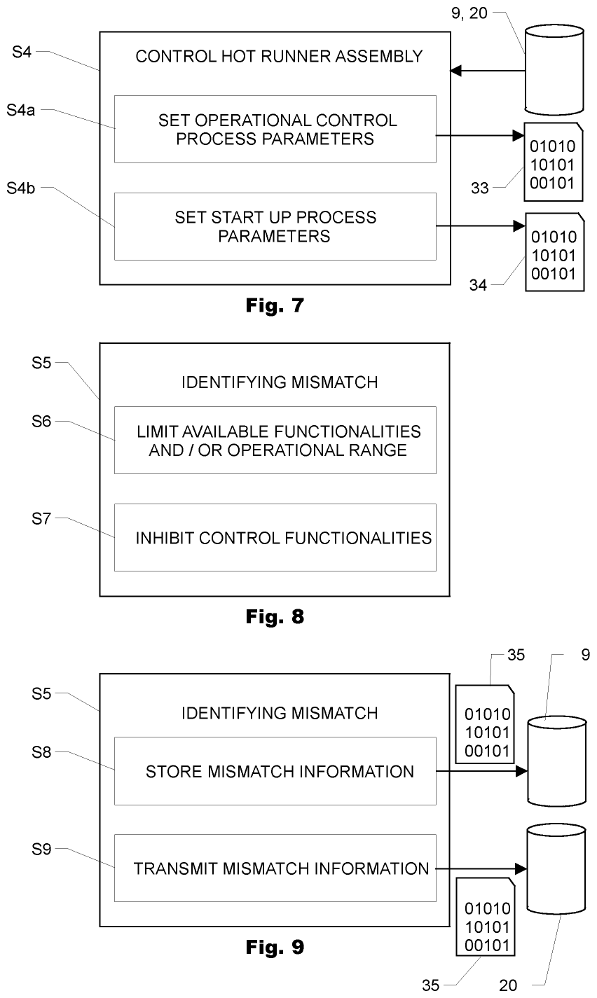

FIG. 7 shows a fourth schematic flow chart illustrating steps, in particular performed by the processor 8 of the hot runner control device 2 for controlling S4 of the hot runner assembly 10.

In step S4a, the processor 8 of the hot runner control device 2, sets control parameters 33 in the hot runner control device 2 in dependence of the identified signature element 16 for operating of the hot runner assembly 10 by the hot runner control device 2. The processor 8 may access the database 9, 20 for retrieving respective control data in dependence of the identified individual signature element 16, signature element type 18, individual hot runner assembly 10 and/or hot runner assembly type 19. Setting the control parameters 33 may comprise that boundaries for different control functions are adjusted accordingly. E.g. the identified heater element type 17 may be configured to reach 100° C. during a specific operation stored in the database 9, 20. This temperature setting is set and used automatically by the processor 8 for operating the hot runner assembly 10. A manual adjustment is not necessary.

In step S4b, the processor 8 of the hot runner control device 2, sets start up process parameters 34 in dependence of the identified signature element 16 for operating a start up process of the hot runner assembly 10 by the hot runner control device 2. The processor 8 may access the database 9, 20 for retrieving respective start up control data in dependence of the identified individual signature element 16, signature element type 18, individual hot runner assembly 10 and/or hot runner assembly type 19. The start up process of a hot runner assembly 10 is a complicated and knowledge intensive process, which conventionally requires a lot of try and error, in particular for manually adjust the settings for an optimized operation of the hot runner assembly 10. This manual adjustment needs to be repeated after changing the hot runner assembly 10 in the injection molding device 1. According to this variation, it is possible to automatically load and set the respective startup process parameters 34 in dependence of the identified signature element 16 etc. The startup of the hot runner assembly 10 and therefore also the startup of the injection molding device 1 is accelerated.

FIG. 8 shows a fifth schematic flow chart illustrating steps, in particular performed by the processor 8 of the hot runner control device 2 in case a mismatch is identified.

In step S5, the processor 8 of the hot runner control device 2 identifies a mismatch 35. The mismatch 35 is identified in that the received signature 21 does not match to at least one reference signature 22 when compared to the at least one reference signature 22. A mismatch 35 may further be identified in case no signature 21 is received, in particular after requesting such a signature 21. Further, a mismatch 35 may be identified in case the received signature 21, especially as measured signal 24 or as measured signal curve 35 does not fulfill a matching threshold with the reference signature 22. A mismatch 35 may result from using a hot runner assembly 10 or a signature element 16 of the hot runner assembly 10 in the injection molding device 1 from a third party supplier.

In step S6, the processor 8 of the hot runner control device 2 is configured to limit the available functionalities and/or to limit the operational range of functionalities of the hot runner assembly 10. Limiting the available functionalities may comprises that the set of operational functionalities is reduced. Limiting the operational range may comprise that certain functions are only available in reduced scope, e.g. only up to 80%.

In step S7, the processor 8 of the hot runner control device 2 is configured to inhibit at least one control functionality for the hot runner assembly 10, in particular for the heater element 17 in case a mismatch 35 is identified. Inhibiting a control functionality or a control function means that this control function is disabled and not available for operating the mismatching hot runner assembly 10. E.g. a boost function is inhibited.

FIG. 9 shows a sixth schematic flow chart illustrating steps, in particular performed by the processor 8 of the hot runner control device 2, in case a mismatch is identified.

In step S8, the processor 8 of the hot runner control device 2 is configured to store the mismatch information 35 in the database 9 located in the hot runner control device 2. The mismatch information 35 is preferably encrypted stored. A maintenance operator may read out the database 9 during the maintenance of the hot runner control device 2.

In step S9, the processor 8 of the hot runner control device 2 is transmits the mismatch information 35 to the remote database 20, in particular accessible by the manufacturer of the hot runner control device 2 or the hot runner assembly 10. The mismatch may be immediately detected and respective measures may be initiated. It is therefore in particular easily possible to remotely detect a mismatch. The mismatch information 35 is transmitted via the communication interface 7.

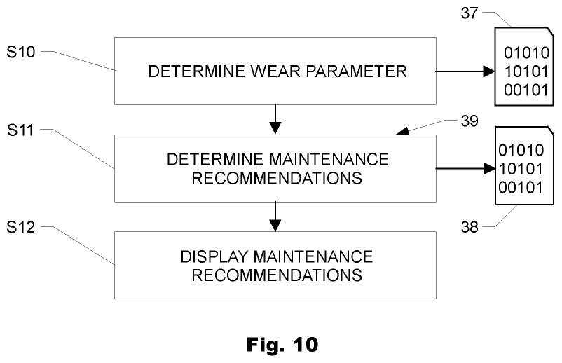

FIG. 10 shows a seventh schematic flow chart illustrating steps, in particular performed by the processor 8 of the hot runner control device 2.

In step S10, the processor 8 of the hot runner control device determines at least one wear parameter 37 of the hot runner assembly 10, by using the received signature 16, in particular by determining and using variations in the received signature 16 over time. The signature 16 may comprise a measured signal 24 or a measured signal curve 25, which may further be indicative for at least one wear parameter 37 of the hot runner assembly 10. Further, the signature 21 may comprise information on the cycle times of the hot runner assembly 10. This information is used to determine at least one wear parameter 37 of the hot runner assembly 10.

In step S11, the processor 8 of the hot runner control device 2 determines a maintenance recommendation 38 in particular using the determined wear parameter 37. The maintenance recommendation 38 is e.g. determined in case the wear parameter 37 fulfills, e.g. reaches or surpasses, a predetermined threshold 39, which is made available to the processor 8. The predetermined threshold 39 is e.g. stored in the database 9, 20.

In step S12, the processor 8 of the hot runner control device 2 displays the determined maintenance recommendation 38 to a user of the hot runner control device 2 and/or presents the maintenance recommendation 38 to the manufacturer of the hot runner control device 2 and/or the hot runner assembly 10. The maintenance recommendation 38 and/or the wear parameter 37 may therefore be transmitted in particular via the communication interface 7 to the remote database 20, were it is accessed and assessed by the manufacturer. Maintenance is thereby e.g. automatically triggered.

### LIST OF DESIGNATIONS

1 Injection molding device
2 Hot runner control device
3 Connection
4 Housing
5 Display
6 User interface
7 communication interface
8 Processor
9 Readable memory/data-base
10 Hot runner assembly
11 Mold inlet
12 Mold manifold
13 Nozzle
14 Sensor
15 Control interface
16 Signature element
17 Heater element
18 Signature element type
19 Hot runner assembly type Electrical resistance
20 Remote database
21 Signature
22 Reference signature
23 Data point
24 Measured signal
25 Measured signal curve
26 Identifier
27 Data series
28 Reference data point
29 Reference signal
30 Reference signal curve
31 Reference identifier
32 Reference data series
33 Control parameters
34 Startup process parameter
35 Mismatch information
36 Server device
37 Wear parameter
38 Maintenance recommendations
39 Predetermined threshold
Ω Electrical resistance
T Temperature
S1 Receive
S2 Access
S3 Identify
S4 Control
S4a Set control parameters
S4b Set startup parameters
S5 Identify mismatch
S6 Limit
S7 Inhibit
S8 Store
S9 Transmit
S10 Determine wear
S11 Determine maintenance recommendations
S12 Display recommendations

1. A hot runner control device for a hot runner assembly comprising a signature element installed in an injection molding device, the hot runner control device comprises a processor configured to:
receive a signature from the signature element, the signature being characteristic for the signature element of the hot runner assembly;
access a database comprising at least one reference signature being characteristic for at least one of the signature elements;
identify the signature element of the hot runner assembly, by comparing the received signature with the at least one reference signature.

2. The hot runner control device according to claim 1, wherein the signature comprises at least one of: a data point, a measured signal, a measured signal curve, an identifier, or a data series from the signature element, and wherein the at least one reference signature comprises the corresponding reference data point, reference signal, reference signal curve or reference data series.

3. The hot runner control device according to claim 1, wherein the processor is configured to identify the hot runner assembly based on the identified signature element.

4. The hot runner control device according to claim 1, wherein the processor is configured to identify at least one of the signature element type or the hot runner assembly type by comparing the received signature, being characteristic for at least one of the respective signature element type and/or being characteristic for the respective hot runner assembly type, with the at least one reference signature.

5. The hot runner control device according to claim 1, wherein the processor is configured to identify at least one of the individual signature element or the individual hot runner assembly by comparing the received signature being characteristic for the respective individual signature element or being characteristic for the respective individual hot runner assembly with the at least one reference signature.

6. The hot runner control device according to claim 1, wherein the signature element is a heater element of the hot runner assembly and the received signature is characteristic for the heater element of the hot runner assembly.

7. The hot runner control device according to claim 2, wherein the measured signal or measured signal curve as the signature is characteristic for a measurable parameter of the signature element, in particular at least one of an electrical resistance of the signature element or a temperature measured at the signature element or the hot runner assembly.

8. The hot runner control device according to claim 1, wherein the processor of the hot runner control device is further configured to:
control the hot runner assembly, in dependence of the identified signature element for operating of the hot runner assembly by the hot runner control device.

9. The hot runner control device according to claim 8, wherein the processor of the hot runner control device is configured to at least one of:
set control parameters in the hot runner control device in dependence of the identified signature element for operating of the hot runner assembly by the hot runner control device; or
set start-up process parameters in dependence of the identified signature element for controlling at least a startup process of the hot runner assembly.

10. The hot runner control device according to claim 1, wherein in case the received signature does not match to at least one reference signature when compared to the at least one reference signature the processor of the hot runner control device is further configured to at least one of:
limit the available functionalities or to limit the operational range of functionalities of the hot runner assembly; or
inhibit at least one control functionality for the hot runner assembly.

11. The hot runner control device according to claim 1, wherein in case the received signature does not match to at least one reference signature when compared to the at least one reference signature the processor of the hot runner control device is further configured to at least one of:
store in a database of the hot runner control device a mismatch information, which determines that the received signature could not be identified; or
transmit a mismatch information to a server device located outside of the hot runner control device, in particular a cloud server, which is not located at the installation site of the injection molding device.

12. The hot runner control device according to claim 1, wherein the processor of the hot runner control device being further configured to determine at least one wear parameter of the hot runner assembly, by using the received signature, in particular by determining and using variations in the received signature over time.

13. The hot runner control device according to claim 12, wherein the processor of the hot runner control device is further configured to determine maintenance recommendations and in particular to display the determined maintenance recommendations to a user of the hot runner control device, in case the determined at least one wear parameter of the hut runner assembly fulfills a predefined threshold, indicating maintenance requirement of the hot runner assembly.

14. The hot runner control device according to claim 12, wherein the processor of the hot runner control device is further configured to control the hot runner assembly in dependence of the determined wear parameter.

15. A method of operating a hot runner control device for a hot runner assembly comprising a signature element installed in an injection molding device, the method comprising the steps of:
receiving, from the signature element a signature, which is characteristic for the signature element of the hot runner assembly;
accessing, a database comprising at least one reference signature being characteristic for at least one of the signature element; and
identifying the signature element of the hot runner assembly, by comparing the received signature with the at least one reference signature.
